(19) United States
(12) Patent Application Publication
(10) Pub. No.: US 2022/0225609 A1
(43) Pub. Date: Jul. 21, 2022

(54) MULTIPLE-LOADED NON-CERAMIC DRY CARRIER PRODUCT AND METHOD

(71) Applicants: David Ian Foster, Lake Charles, LA (US); Benjamin Kyle Stringer, Chelsea, AL (US)

(72) Inventors: David Ian Foster, Lake Charles, LA (US); Benjamin Kyle Stringer, Chelsea, AL (US)

(21) Appl. No.: 17/715,696

(22) Filed: Apr. 7, 2022

Related U.S. Application Data
(63) Continuation-in-part of application No. 15/858,456, filed on Dec. 29, 2017, now abandoned.
(60) Provisional application No. 62/458,620, filed on Feb. 14, 2017.

(51) Int. Cl. A01N 25/12; A01N 63/20

(52) U.S. Cl. CPC A01N 25/12; A01N 63/20

(57) ABSTRACT

A multiple-loaded non-ceramic dry carrier product and method for the loading of reagent liquids, solids dissolved in liquids as solutions, suspensions, and solids heated to reduce viscosity, onto perlite, pumice, scoria, or exfoliated vermiculite or activated charcoal particles, which are used as carriers, and then dried in multiple iterations to achieve a powdered, free-flowing material for use in hydraulic fracturing processes and other uses such as environmental remediation and animal control, providing improvements in cost, carrier stability, and chemical retention properties.

### CROSS-REFERENCE TO RELATED APPLICATIONS

This application is a continuation-in-part of pending application Ser. No. 15/858,456, filed on Dec. 29, 2017, for Dry Liquid Concentrate Slurries for Hydraulic Fracturing Operations, which claimed the benefit of provisional application Ser. No. 62/458,620, filed on Feb. 14, 2017, for Composition and Method for Internally Loading Liquids onto Scoria, Perlite, Pumice, Vermiculite, and Activated Charcoal, to achieve liquid infused dried carriers (DLC), the full disclosures of which are incorporated by reference herein and priority of which are hereby claimed

### BACKGROUND OF THE INVENTION

This invention is directed toward the loading of reagent liquids, solids dissolved in liquids as solutions, suspensions, and solids heated to reduce viscosity, onto scoria, perlite, pumice, or exfoliated vermiculite or activated charcoal particles, which are used as carriers, and then dried to achieve a powdered, free-flowing material, for use in hydraulic fracturing processes and other uses such as environmental remediation and animal control.

A carrier provides for dry handling of normally liquid materials and can also provide for a slowed or regulated release of carried chemicals or substances into an environment. The carried chemicals or substances are called reagents here. The term reagent includes substances which might also be considered reactants. The carrier can absorb or adsorb reagents, usually liquids or solids dissolved or suspended in liquid, and can carry the reagents to a desired location. Adsorption is adhesion to a surface of another substance. Absorption is dissolving or permeating into another substance. The term sorption encompasses both processes, while desorption is the reverse of it. Carriers are used in hydraulic fracturing processes, which are used in hydrocarbon production operations and also for other purposes. Carriers can be used in environmental operations, including environmental remediation operations where, for example, a surfactant, dispersant, or neutralizing substance is deployed as the reagent. Carriers can also be used for activities such as animal control, carrying attractants or repellents.

A carrier is different from a proppant. A proppant is a solid material designed to keep an induced hydraulic fracture open, during or following a fracturing treatment. A carrier is a porous material to which well treatment and formation chemicals are added. Both proppant and carrier are added to a fracking fluid, which may vary in composition depending on the type of fracturing used, and may be gel, foam, gas or slickwater-based. Fracking fluids make tradeoffs in material properties, including viscosity, where more viscous fluids can carry more proppant and carrier, energy or pressure demands to maintain a certain flux pump rate (flow velocity) that will conduct the proppant and carrier appropriately, pH, various rheological factors, and other considerations, such as toxicity and degradability. After substances or substrates are carried down hole with a carrier, the substances or substrates can be expanded by a pressurized propellant and held in an expanded state by a proppant of granular solid material, such as sand. Although it is possible to use a porous proppant as a carrier such use is not advantageous because for any material an increase in carrier properties will mean a decrease in proppant properties, and vice versa.

Perlite, pumice, and scoria are considered to be volcanic glasses because they lack the crystal structure characteristic of minerals, including clay minerals. Scoria and pumice are composed of glassy fragments and may or may not contain some crystal-like phenocrysts. Scoria is denser than pumice and perlite, and will tend to sink in liquids while the others will tend to float or have some buoyancy. Perlite, pumice, and scoria have high crush strength, which is desirable for downhole hydraulic fracturing uses. Materials with amorphous noncrystalline character are considered to be glass and not ceramics, despite some similarities in properties. Some glass materials can be converted by heat treatment into semi-crystalline materials known as glass-ceramics. Vermiculite is considered to be a mineral having some crystal structure, but is subject to exfoliation or intercalation by heating, greatly reducing its specific gravity and increasing its absorptive properties. Exfoliated vermiculite does not have significant clay-mineral or ceramic properties. Activated carbon is a non-ceramic material with adsorptive properties known in the art. Exfoliated vermiculite and activated carbon do not have high crush strength, and are less appropriate for downhole hydraulic fracturing use and are more appropriate for uses such as environmental remediation and animal control.

There are examples of porous proppants being used down hole, but this use can be cost prohibitive. Our liquid infused dried carrier is added to the proppant as a carrier to provide a substrate for inhibitors or other treatments used in down hole well treatment, reducing the cost of the treatments. Additionally, activated charcoal or vermiculite may be used as carriers in other applications where a high crush strength is not an issue. For down hole applications, the loading of the liquid infused-and-dried carriers is increased by additional application of liquid and further drying. This multiple loading may be repeated until the void space is full of liquid or until the required characteristics are met. We are not using single application for down hole. Other applications may or may not use multiple loadings.

Presently known carriers, such as diatomaceous earth or precipitated silica, are crystalline silicates. Crystalline silicates can cut the throat and lungs if inhaled, and can cause other environmental damage, and consequently are subject to health and safety rules and regulations for use and for disposal which add complexity and costs to their use as carriers. Expanded perlite, pumice, and scoria, and exfoliated vermiculite and activated charcoal are non-crystalline, and do not present the same dangers for use and disposal.

Presently known carriers do not have the carrier stability or chemical retention duration needed for some hydraulic-fracturing uses or for environmental applications and animal control.

Carriers may be infused with liquid substances using various equipment known in the art, as follows:

Mixers are used to process materials that must be thoroughly broken down and blended. A paddle mixer has large paddles that rotate around a horizontal rotating axis. A static mixer has flat, thin, ribbon-shaped blades and no internal moving parts, but contain strategically-designed blockages that forcefully blend the materials together. Static mixers are sanitary and easy to clean and maintain because of the simple arrangement of their blades. High shear mixers are machinery that operate at a high speed, and are designed to apply emulsification, disintegration, particle size reduction, dispersion, and homogenization to a variety of solid and liquid materials. They work best in industries like food prep, paper, pulp, and pharmaceuticals. Drum mixers are a type of mixer that is built to blend low-to-medium-viscosity materials such as adhesives or cement. Drum mixers are made from gallon drums that rotate to mix materials of greatly varying particle sizes. Usually, they mix low to medium viscosity materials, like slurries. Food mixers are used to give a food product a particular effect or appearance once mixed with certain materials. They are commonly used to beat, knead, whip, blend, mix, or fold edible ingredients. Because of strict food and health regulations, these mixers must be sanitary. The term blender refers to mixers with sharp blades that work at high speeds. These are best for breaking material down into small pieces. Planetary mixers are agitators used in cooking (mostly to make dough) or in chemical mixing. They are called planetary mixers because they orbit around the outer edges of mixers bowls on an elliptical or circular axis. Homogenizers are used to completely blend and break down materials. Industries such as science, technology and food processing have been using homogenizers for years. Milk and cream are familiar examples of edible products that are processed by homogenizers. Emulsifiers are a high-velocity type of mixer that uses a perforated screen to mix materials that are otherwise highly difficult to blend. Agitators are used to process substances with low viscosities such as liquids. The agitation process is mainly a process aid, acting as a secondary procedure in the overall process. Agitators are much less effective with thicker, more viscous materials. Batch mixers are used mainly to blend materials with varying lengths of mixing. To carry out this process, the mixers blend a single load of material, and are then refilled with the next material, or batch. Ribbon mixers are static, meaning that they do not have any moving parts. Their flat, thin blades instead function as stationary roadblocks that the materials they are mixing must go around. When they do this, the materials mix and blend together. Ribbon mixers, like most static mixers, are easy to clean. An advantage of ribbon mixers is that they can operate in batch mode or in continuous mode, where the final product is drawn off continuously from the end of the mixer. Industrial mixers consist of a large vat or tank to hold the materials, and blades that agitate the materials using force. Industries that involve large-scale commercial production will most likely use industrial mixers, as they are capable of processing materials in large volumes.

In-line mixers are mixers placed inside pipes, or in line with material flows. Instead of mixing materials in a tank, they mix them in the pipe. This allows processing exceptionally large batches of material while using an exceptionally low amount of horsepower, with a very consistent batch turnover. There are two main types of in-line mixer: static in-line mixers and dynamic in-line mixers. Static in-line mixers work using stationary contoured mixing parts, while dynamic in-line mixers use a combination of high-speed rotating parts and pump pressure.

Stand mixers, also known as standing mixers, are mounted on top of their motor so that they can stand upright. Stand mixers are easy to diversify, which is why they are available in anything from 1-gallon countertop styles to commercial styles upwards of 25 gallons. Portable mixers are mixers that can be moved from one site to another to provide much needed mixing and blending that cannot be performed off-site. For example, contractors often use portable cement mixers to perform small jobs, like driveway concrete mixing. Portable mixers can be mounted on trucks or trailers as in-transit mixers, or they can be moved around on their own and powered by electricity. Tank mixers, or mixer tanks, are mixing machines that use tanks to mix their materials. Usually, tank mixers are made from stainless steel. A shaker can be considered a version of a tank mixer, but using agitation by shaking instead of using blades or paddles. The tank is supported on springs and is vibrated by use of an eccentric cam or other means.

The standard features of a mixer are a main chamber, which is usually a large vat or tank, and a motorized set of paddles or blades that rotate on an axis. Depending on the application for which the mixer is used, it may have either a set of flat paddles or sharp blades. These attachments are usually removable in order to enable the mixer to work with as wide a variety of materials as possible. Mixer systems offer their users the benefits of consistency, efficiency, ease of use and durability. While it is possible to mix materials without them, mixers offer a consistency of output that is hard to find elsewhere. Plus, other methods do not really mix materials nearly as well and as quickly as they do. Mixers are designed to work well and last a long a long time. With them, the products will come out thoroughly and evenly mixed.

Most mixers are made from stainless steel due to the sanitary and corrosion-resistant nature of the material. Other materials that may be used are aluminum, cast iron, steel, titanium, or thermoplastic. When designing a mixer, manufacturers must make decisions about details, such as: the basic container type, the type and design of the blades, and the power level of the motor. They make these decisions based on application specifications, such as: the thickness and viscosity of the material to be mixed, the volume of material to be mixed, the corrosiveness of the material(s) to be mixed, the space available to the customer, and required levels of sanitation. While it is possible for mixer manufacturers to customize mix equipment, it is not common. Custom-built and specialized machines might enable operators to have more control over the mixing process. Also, because they are specialized custom machines wear down less quickly than standard models. Some of the most common specializations include using high velocities to mix multiple materials and modifying the mixer to be able to handle drastic drops in pressure.

Spray driers provide for mixing the liquid and solid components in a tank, using one of the above mixing systems, to produce a slurry or partially absorbed matrix, then pumping the mixture through nozzles in a spray tower. Heat is applied and the agglomerated particles are dry by the time they reach the bottom of the drier. Although this produces uniform coating and absorption of the liquid into the carrier the particles stick together to produce granules. There has to be an extra comminution step, using a grinder or mill, to break up the granules back into their original powder form and mesh size.

In a conveyor system, the carrier is loaded from a hopper, etc., onto a conveyor belt and passed under a spray bar. The liquid to be absorbed is sprayed onto the carrier from a tank, etc., at a specified spray rate and conveyor speed in order to obtain an optimum coating, and thus absorption, of the liquid onto the carrier. As the liquid/carrier mix travels down the conveyor, it passes through a drying oven or overheat lamps to be dried. A disadvantage of this method is that the liquid/solid mix clumps together as it dries and must be broken down back into particles, as with a spray drier.

Rosenmund is a specialized system which can blend, mix, dry, filter, comminute, and apply pressure or vacuum, in one unit. The liquid is sprayed onto the solid carrier for partial absorption or mixed to form a slurry. During the drying period high speed blades prevent clumping or granules from forming until the material is dried.

Mixing of materials may be accomplished in various ways depending on the required results:

(1) Using a tank or drum mixer with spray bar(s) to ensure uniform coating, and thus absorption of the liquid onto the carrier. Mixing efficiency is determined by the type of spray bars and nozzles, rate of spray of liquid, speed of mixer, etc. (2) Using a ribbon mixer with static blade configurations and spray bar(s) to obtain optimum absorption of liquid on the carrier. This type of mixer can be run continuously or in batch mode. (3) Using a conveyor belt with spray bar(s) to coat the carrier as it moves under the liquid spray. (4) Pumping the liquid into a tank filled with carrier through a bottom feed. As the liquid passes through the carrier, it fills the voids in the carrier more efficiently than a mixing method where not all the air may be displaced from the carrier. This method may by enhanced by using a vacuum to assist in removing the air from the carrier. (5) Loading the carrier into a shaker by means of a hopper or other methods then adding the liquid in increments to obtain the required loading with shaking or agitation between additional increments.

Drying of materials may be accomplished in various ways depending on the required results:

(1) Drying within the mixing system—Piping is inserted into the system to provide various drying scenarios. Hot, warm or cold air, or an inert gas is pumped through the piping into, under, or onto the mix during rotation of the drum, blades or screw system. Or material can be transferred to another tank or drum where piping and gas flow can be used, allowing a system to be used in a semi-batch mode to increase workflow. Or (2) Pumping of the mix into a drying system—once mixed by one of the stated methods the liquid—carrier mix is transferred to an external drier. This may be a conveyor system with drying oven or heat lamps.

Alternatively, the mix maybe loaded onto pans to be dried in a drier with a constant flow of air or inert gas. However, this method does not allow separation of the particles during drying, and the resultant product is a solid block of concrete-like consistency. Even with comminution by grinding or milling the product does not return to its original mesh size and remains in lumps. When any system of mixing or drying is used there must be a vapor recovery system to trap and recover vapors coming off the system which may be flammable or hazardous to health.

Present methods for preparation of chemical-infused carrier have the disadvantage that the treated carrier still contains void space which can potentially accommodate additional infusion and additional loading of the same liquid or of a different liquid. There remains a need for fracturing fluids and carrier alternatives to those presently available in order to achieve better competition and economics, carrier stability, and chemical stability and retention duration for the many varied conditions and processes that use some form of hydraulic fracturing, including environmental applications and animal control. Multiple passes of liquid through previously treated carrier can be advantageous. The loading of the material prepared by a first course of mixing and drying, as above, can be increased by treating it with more of the same liquid or a different liquid which is compatible with the first, using the same or different treatment methods. In this way the loading of a corrosion inhibitor can be increased, or a scale inhibitor or other downhole chemical can be added. When the chemical-infused carrier is more fully loaded, significantly less of the product might be required per injection, and significantly fewer or less-frequent injection might be required, lowering transport, storage, and application operations costs.

U.S. Pat. No. 5,964,291, issued on Oct. 12, 1999 to assignee AEA Technology PLC for “Well Treatment,” discloses chemical treatment agents supplied to a well or borehole extending through an earth formation, by subjecting the well to a fracturing treatment with a high-pressure fluid and proppant particles. In the system, invented by Hugh Malcolm Bourne and Peter Arne Read, the proppant particles are thereby trapped in fractures in the earth formation. Some or all of the proppant particles are of porous insoluble inorganic material, and are impregnated with a chemical treatment agent, such as a scale inhibitor or a corrosion inhibitor. The porous particles may be of a ceramic or oxide material, such as a silica and/or an alumina-based material.

U.S. Pat. No. 6,209,646 was issued on Apr. 3, 2001 to assignee Halliburton Energy Services, Inc., covering “Controlling the Release of Chemical Additives in Well Treating Fluids.” In the '646 Patent, methods invented by Baireddy R. Reddy et al. of controlling the rates of release of chemical additives into treating fluids are provided. The methods are essentially comprised of causing a chemical additive in liquid form to be absorbed into a porous solid material whereby the chemical additive is encapsulated thereby, and when the resulting encapsulated chemical additive is combined with the treating fluid, the chemical additive is slowly released into the treating fluid. After being encapsulated, the liquid chemical additive is combined with the treating fluid and the treating fluid containing the encapsulated chemical additive is introduced into a well.

U.S. Pat. No. 7,493,955 was issued to assignee BJ Services Company on Feb. 24, 2009 for “Well Treating Compositions for Slow Release of Treatment Agents and Methods of Using the Same.” The '955 Patent discloses a composite invented by D. V. Satyanarayana Gupta et al. of a well treatment agent adsorbed onto a water-insoluble adsorbent, useful in the treatment of oil and gas wells, which may be introduced, as a well treatment fluid, with a carrier fluid. The water-insoluble adsorbent may be activated carbon, silica particulate, precipitated silica, zeolite, diatomaceous earth, ground walnut shells, fuller's earth, and organic synthetic high molecular weight water-insoluble adsorbents. Suitable as the well treatment agent are scale inhibitors, corrosion inhibitors, paraffin inhibitors, salt inhibitors, gas hydrate inhibitors, asphaltene inhibitors, oxygen scavengers, biocides, foaming agent, emulsion breakers, and surfactants.

US Publication No. 2014/0206080, which was published on Jul. 24, 2014 by inventors Ramiro Trevino et al., discloses “Composition and Method for Delivery of Living Cells in a Dry Mode Having a Surface Layer.” The system generally relates to compositions and methods of delivering living cells in a dry mode, wherein the compositions include a surface layer disposed on the outer surface of the composition that is permeable to carbon dioxide and oxygen. The compositions may be used to deliver living cells to a delivery point without the use of expensive refrigerants such as dry ice or liquid nitrogen.

US Publication No. 2011/0220355, published on Sep. 15, 2011 by Phillip B. Kaufman et al., discloses a “Non-spherical Well Treating Particulates and Methods of Using the Same,” specifically disclosing that “[n]on-spherical particulates are useful in the stimulation of subterranean formations. A proppant pack composed of the non-spherical particulates exhibits greater porosity than a corresponding proppant pack composed of spherical particulates. Non-spherical particulates which are hollow and non-porous may further be at least partially filled with a chemical treatment agent including water-soluble or oil-soluble chemical treatment agents.”

International Publication No. WO 1999/036668, published on Jul. 22, 1999 by Philip Webb, discloses a “Well Treatment,” specifically disclosing “[p]articles containing scale inhibitor may be made by contacting porous ceramic beads with a solution of scale inhibitor, and then drying the beads. If the dried beads are then contacted with a solution containing a high concentration of polyvalent cations, for example 2.5 M calcium ions, and then dried again, then the rate of release of scale inhibitor when the beads are subsequently contacted with water is reduced. Varying the concentration of the polyvalent cation in the range 0.1 to 5.0 M varies the rate at which the inhibitor is subsequently released. The beads may be used as fracture proppants or in a gravel pack so as to suppress scale formation in an oil or gas well.”

### SUMMARY OF THE INVENTION

This invention provides a multiple-loaded non-ceramic dry carrier product and method, for the loading of reagent liquids, solids dissolved in liquids as solutions, suspensions, and solids heated to reduce viscosity, onto perlite, pumice, scoria, or exfoliated vermiculite or activated charcoal particles, which are used as carriers, and then dried, in multiple iterations, to achieve a powdered, free-flowing material for use in hydraulic fracturing processes and other uses such as environmental remediation and animal control, providing improvements in cost, carrier stability, and chemical retention properties.

This invention provides viable reagent chemical carriers that improve costs, carrier stability, and chemical retention for each of the many varied conditions and varied processes which use some form of hydraulic fracturing, by loading liquids, solutions, suspensions, or heated solids onto non-ceramic carrier, to achieve a liquid infused dried carrier by multiple loadings and dryings, for use in processes where a substance or substrate is to be expanded by a pressurized propellant and held in an expanded state by a proppant of granular solid material, including hydraulic fracturing for hydrocarbons, manufacturing, oil well treatment and production chemicals. Multiple-loaded non-ceramic dry carriers may be used for biological treatment and remediation systems, animal control such as attractants or repellents, cleaning chemicals, and combinations of the above, and any material, manufacturing process, or remediation process benefiting from the dried material.

### BRIEF DESCRIPTION OF THE DRAWINGS

Reference will now be made to the drawings, wherein like parts are designated by like numerals, and wherein:

FIG. 1 is a schematic representation of the process of the present invention.

### DETAILED DESCRIPTION OF THE INVENTION

This invention provides a multiple-loaded non-ceramic dry carrier product and method for the loading of reagent liquids, solids dissolved in liquids as solutions, suspensions, and solids heated to reduce viscosity, onto perlite, pumice, scoria, or exfoliated vermiculite or activated charcoal particles, which are used as carriers, and then dried in multiple iterations to achieve a powdered, free-flowing material for use in hydraulic fracturing processes and other uses such as environmental remediation and animal control, providing improvements in cost, carrier stability, and chemical retention properties.

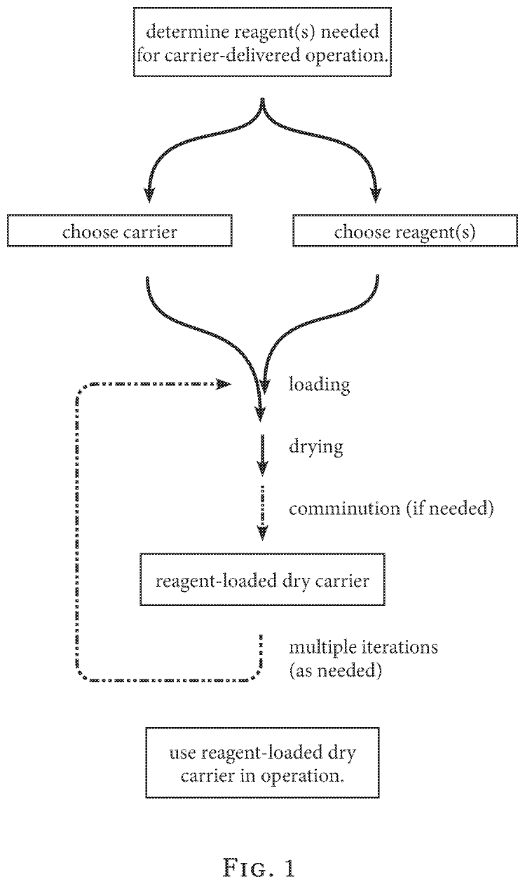

Referring to FIG. 1, a schematic representation of the process of loading the multiple-loaded non-ceramic dry carrier. The specific carrier materials used are non-ceramic materials. The non-ceramic materials having high crush strength, which are therefore more suited for most downhole hydraulic fracturing operations, are expanded perlite, pumice, and scoria, which are related volcanic glass ejecta, all with low density, with expanded perlite having the lowest density and scoria having the highest. Exfoliated vermiculite and activated carbon are non-ceramic materials, which do not have high crush strength and are less appropriate for downhole hydraulic fracturing use and are more appropriate for uses such as environmental remediation and animal control.

Ceramics are made by calcining clay minerals or pure alumina to create porous carriers for catalysts, filtration media, etc., and may be modified. The chemical composition of manufactured ceramic materials may be modified by chemically altering the structure by exchange of ions on active sites within the structure. The non-ceramic materials expanded perlite, pumice, scoria, exfoliated vermiculite, and activated carbon cannot be modified in this way as they have been chemically formed naturally already and do not undergo further chemical reaction as there are no active sites. Thus, they are chemically stable, as opposed to manufactured ceramics.

The non-ceramic carrier materials expanded perlite, pumice, scoria, exfoliated vermiculite, and activated carbon are capable of a higher percentage loading of reagent than other materials presently used as carriers, such as diatomaceous earth. As treated above, diatomaceous earth and other crystalline silicates can damage the health of persons using those materials and can damage the health of humans or animals exposed to such materials in the environment. The non-ceramic carrier materials of the multiple-loaded non-ceramic dry carrier product and method do not present those health risks.

The non-ceramic materials expanded perlite, pumice, scoria, exfoliated vermiculite, and activated carbon, as used in this multiple-loaded non-ceramic dry carrier invention, form porous small and granular particles, often substantially spherical, as opposed to larger and more elaborate structures such as tubular or cylindrical structures as are formed by, for example, graphene. The porous small and granular particles are much less likely to affect the fluid conductance or electrical properties of a formation, and are therefore much less likely to interfere with telemetry equipment. The porous small and granular particles have aspect ratios in the range of approximately 0.5:1.0 to 0.95:1.0.

For oilfield downhole use, the particle size of the carriers is in the range of 8 to 100 microns with an optimal size of 10 to 20 mesh. However, the optimal size and range may be tailored according to the specific use. For carriers used with surfactants, microbes, animal attractants, etc. the particle size may be of the 8 to 100 micron range but may be up to ½″ granules in size. Depending on the exact needs for a specific operation, the specific properties of one of the carrier materials might present an advantage over the others. For example, expanded perlite is less dense than water and will generally be at least somewhat buoyant in most fluids even after loading, while scoria is more dense than water and will be much less buoyant in heavy fluids and not at all buoyant in water. The difference in buoyancy might be a significant factor in some operations, where, for example, it might be beneficial to carry a surfactant or dispersant to concentrate at a higher or a lower level in a pool of oil-contaminated water.

The reagent or reagents used are liquids, solids dissolved in liquids as solutions, suspensions, and solids heated to reduce viscosity. The reagents are meant to be injected or otherwise applied in order to cause, prevent, advance, retard, or control some aspect of the operation being performed. Many examples of various reagents and various operations are given below. The reagent or reagents are loaded onto the carrier material using one or more of the methods treated above, and are dried, again using one or more of the above methods. The result is a reagent-loaded dry carrier, which after the initial loading and drying is not yet loaded to full capacity. Use of dry loaded carrier is crucial in processes where a substance or substrate is to be: (a) expanded by a pressurized propellant and held in an expanded state by a proppant of granular solid material, including, without limitation, hydraulic fracturing for hydrocarbons, manufacturing, oil well treatment and production chemicals, or (b) non-pressurized for biological treatment and remediation systems, animal attractants or repellents, certain fragrances, cleaning chemicals, combinations of the above, and any material, manufacturing process, or remediation process benefiting from these materials. If the drying method causes agglomeration of the particles or any change of effective particle size and shape, the dried particles are comminuted and returned to their small and granular size and shape.

Even after a first iteration of loading with reagent and drying, the carrier material will have void space not loaded with reagent. Such void space is inefficient and requires a greater amount of partially loaded carrier to be applied in order to apply a given amount of reagent. For downhole operations, this might mean more trips and more operation costs. A possible reason for this remaining void space is migration of reagent, during drying, from pores at the surface of particles to pores toward the center. The initial uptake of reagent at the surface of the particles might block further uptake until the reagent migrates toward the center. The multiple-loaded non-ceramic dry carrier of the invention provides for multiple iterations of loading and drying to achieve a substantially complete loading of reagent on the carrier. The non-ceramic carrier materials provided by the invention are able to tolerate multiple iterations of loading and drying because the materials are chemically stable and non-reactive, in contrast with ceramic materials. It is possible that for a specific operational use, for a specific reagent or combination of reagents, for a specific carrier, and for specific mixing and drying methods, a single iteration of loading and drying could be sufficient to produce a reagent-loaded dry carrier which either fully loaded or fully-enough loaded for the operational use. In such a case, the needed additional iterations of loading and drying will be zero. Such a case is contemplated by this invention, with the necessary additional iterations being zero.

In one embodiment of the multiple-loaded non-ceramic dry carrier invention, downhole chemicals are loaded onto carriers such as scoria, perlite, and pumice, and are introduced to the formation via being mixed with propellants and proppants or other means. In downstream gas and oil well production, chemicals are loaded onto such carriers such as scoria, perlite, pumice, and so forth, and introduced into the stream by means of a bed placed inline. The carrier substrates can impart time release properties, avoid undesirable side reactions prior to use, improve shelf life, and increase distribution of the treatment system. Perlite, pumice and vermiculite in particular have a low density, and can float on water. Adding a liquid and drying can adjust the material density so that the treated materials are heavier than water and will sink when applied to a water environment. Scoria, in contrast, possesses a high density, naturally which makes it preferable for use in applications where the material needs to be heavier than water initially. Meanwhile, scoria and pumice each possess hard structures that can allow for higher-crush applications.

In another embodiment of the multiple-loaded non-ceramic dry carrier invention, cleaning chemicals, such as surfactants, can be loaded onto carriers, such as scoria, perlite, pumice, and vermiculite, for delivery on hydrocarbon contaminated substrates. An advantage of using these materials instead of clay is that when they absorb water, they do not turn into a sludge, retaining their physical structure. This makes clean up easier and more environmentally friendly.

In another embodiment of the multiple-loaded non-ceramic dry carrier invention, cleaning chemicals, such as surfactants, can be loaded onto carriers, such as scoria, perlite, pumice, and vermiculite, and where the surfactant loading can be increased by repeated addition and drying of the carrier for delivery on hydrocarbon contaminated substrates.

In another embodiment of the multiple-loaded non-ceramic dry carrier invention, microbial and/or enzymatic systems are mixed with a surfactant and loaded onto carriers, such as scoria, perlite, pumice, and vermiculite. The surfactants provide an initial food source for the microbes and to solubilize oils, fats, etc., for microbes and enzymes to act on. The surfactant-microbe-enzyme combination has been shown to work synergistically on oil spills, as opposed to individual treatments of each component. The densities of scoria and pumice can allow the system to sink to the bottom of the water, or can be adjusted by amendments to gradually sink or float. The particle size of the carrier can be selected to lock into the soil substrate or facilitate application via rotary spreader. Proper carrier substrate formulation can allow oil and stain remediation of concrete or gravel, such as found at fueling stations, fuel transfer and oil change facilities, railway beds and yards, convenience stores, and so forth.

In another embodiment of the multiple-loaded non-ceramic dry carrier invention, liquid animal attractants (such as pheromones and/or flavors or fragrances) or repellents are loaded onto carriers such as scoria, perlite, pumice, vermiculite, and activated charcoal, which possess a large internal carrying capacity. The internally absorbent carriers can act to extend the shelf life of normally temperature, oxygen and light sensitive agents, as well as allow time-release action.

Examples of uses of the multiple-loaded non-ceramic dry carrier are:

A 57.1 wt. % downhole scale inhibitor is produced by loading 13.3 grams of inhibitor on 10 grams of perlite.

A 33.3 wt. % carrier downhole scale inhibitor is produced by loading 10 pounds of inhibitor on 20 pounds of pumice.

A 33.3 wt. % carrier downhole corrosion inhibitor is produced by loading 10 pounds of inhibitor on 20 pounds of pumice.

A 50 wt. % carrier downhole corrosion inhibitor is produced by loading 5 grams of inhibitor on 5 grams of perlite.

A 54.3 wt. % carrier downhole scale inhibitor is produced by loading 38 ounces of inhibitor on 32 ounces of perlite.

A 60 wt. % carrier downhole corrosion inhibitor is produced by loading 24 ounces of inhibitor on 16 ounces of perlite.

A 61.4 wt. % slurry of tire pyrolysis oil is produced on perlite powder with up to ½-inch particles. Tire pyrolysis oil can be used to remove paraffinic compounds in down-hole applications.

An 18.7 wt. % slurry of tire pyrolysis oil is produced on scoria granules up to ⅛ inches in diameter. Tire pyrolysis oil can be used to remove paraffinic compounds in down-hole applications.

A 20.4 wt. % slurry of tire pyrolysis oil is produced on pumice with granule sizes ranging from ⅛ to ½ inches in diameter. Tire pyrolysis oil can be used to remove paraffinic compounds in down hole applications.

A 61 wt. % carrier of 10% surfactant solution is produced by loading 17 grams of a 10% surfactant solution onto 11 grams of activated charcoal. The surfactant used is made by mixing 11 grams of Wisk concentrate in 93 grams of water. The activated carbon used may be Aqua-Tech. This liquid infused dried carrier can be used as a cleaner and hydrocarbon remediation product. The liquid infused dried carrier allows the surfactant to stay in place and time release into or on the treated matrix such as soil, or other solid substrates.

A 10 vol. % of surfactant in water was loaded onto a low porosity perlite to show how loadings increase with multiple additions of the same liquid and after drying. An initial loading of 23.7 wt % was obtained after drying. A second infusion of surfactant produced a loading of 36.8 wt %. A third infusion of surfactant produced a loading of 51.5 wt %.

A 52 wt. % bacterial carrier is produced by loading 12 grams of the bacteria solution onto 11 grams of activated charcoal. The bacterial solution used may be AquaVitro Remediation Bacteria, designed to remediate organic waste such as food, sludge, and detritus. The activated carbon used may be Aqua-Tech. The liquid infused dried carrier formulation of the bacteria allows its waste remediation properties to stay in place and time release into the treated matrix such as soil, or other solid substrates.

A 52 wt. % bacterial carrier is produced by loading 14 grams of the bacteria solution onto 13 grams of activated charcoal. The bacterial solution used may be AquaVitro Seed Bacteria, which contains anaerobic and aerobic facultative and nitrifying and denitrifying bacteria. The activated carbon used may be Aqua-Tech. The liquid infused dried carrier formulation of the bacteria allows its waste remediation properties to stay in place and time release into the treated matrix such as soil, or other solid substrates.

A 57.5 wt. % carrier of microbes from First Generation Microbials, LLC is produced on perlite powder with up to ½-inch particles.

A 10.3 wt. % carrier of microbes from First Generation Microbials, LLC is produced on scoria granules up to ⅛ inches in diameter.

A 16.2 wt. % carrier of microbes from First Generation Microbials, LLC is produced on pumice with granule sizes ranging from ⅛ to ½ inches in diameter.

An 81.3 wt. % carrier of microbes from First Generation Microbials, LLC is produced on vermiculite with granule sizes ranging from 1/16 to ½ inches in diameter.

A 50 wt. % bacteria carrier is produced by loading 1 pound of bacteria on 1 pound of vermiculite.

An 81.3 wt. % bacteria carrier is produced by loading 87.2 grams of bacteria on 20 grams of vermiculite.

A 56 wt. % bacterial carrier is produced by loading 14 grams of the bacteria solution onto 11 grams of activated charcoal. The bacterial solution used may be AP StressZyme, which is designed to remove sludge from aquatic surfaces. The activated carbon used may be Aqua-Tech. The liquid infused dried carrier DLC formulation of the bacteria allows its waste remediation properties to stay in place and time release into the treated matrix such as soil, filter media, gravel, or other solid substrates.

A 52 wt. % bacterial carrier is produced by loading 13 grams of the bacteria solution onto 12 grams of activated charcoal. The bacterial solution used may be Bio-Spira, which contains nitrifiers designed to remove ammonia and nitrite from aquatic environments. The activated carbon used may be Aqua-Tech. The liquid infused dried carrier formulation of the bacteria allows its waste remediation properties to stay in place and time release into the treated matrix such as soil, filter media, gravel, or other solid substrates.

A 48 wt. % carrier of hog attractant is produced by loading 9.1 grams of a hog attractant onto 10 grams of activated charcoal. The activated carbon used may be API Activated Filter Carbon. The hog attractant used may be Black Gold hog attractant. The liquid infused dried carrier DLC formulation of the liquid hog attractant allows the active ingredient to lock into place and time release into the soil matrix.

A 38 wt. % carrier of thymol is produced by loading 6.2 grams of thymol onto 10 grams of activated charcoal. The activated carbon used may be API Activated Filter Carbon. The liquid infused dried carrier formulation of the thymol allows its germicidal properties to stay in place and time release into the treated matrix such as soil, or other substrates.

A 32 wt. % of peppermint oil is produced by loading 4.8 grams of the active ingredient onto 10 grams of activated charcoal. The activated carbon used may be API Activated Filter Carbon. The liquid infused dried carrier formulation of the peppermint oil allows its animal repellent properties to lock in place and time release in the soil matrix or other substrate where it is applied.

A 33 wt. % carrier of eucalyptol is produced by loading 5.0 grams of the active ingredient onto 10 grams of activated charcoal. The activated carbon used may be API Activated Filter Carbon. The liquid infused dried carrier formulation of the eucalyptol allows its animal repellent properties to lock in place and time release in the soil matrix or other substrate where it is applied.

A 58% active ingredient carrier of hog attractant is produced by loading equal portions of Black Gold hog pheromone, Pigout brand liquid hog attractant, and water onto perlite. The mixing was performed in a clear plastic sealable container to emulate a drum mixer process and to minimize escaping “fines.” The resulting product is a fluffy powder with no clumping. Other attractants may be used instead of or to complement the above formulation.

Ten (10) wt. % of peanut butter powder is added to compliment the hog attractant listed above. This formulation improvement was created after increased feral hog activity was observed around peanut fields. The peanut butter powder does not load into the carrier matrix, rather it mechanically mixes in interparticle space between the carrier particles.

The hog attractant listed above is treated with a denaturant or fragrance to discourage consumption by humans and certain animals. Feral hogs and rats are attracted to all liquids in the formulations. Human consumption is by accidental ingestion, primarily. By varying the concentration and type of the denaturant it is possible to tailor formulations which deter consumption by humans and are attractive to hogs, rats, squirrels, or other animals. For example, a loading of 10 ppmw of Denatonium Benzoate in the formulations will repel rats and squirrels, but not feral hogs. A minimal loading of 10 ppbw is bitter to humans and deters consumption, whereas that loading is not detected by animals. Fragrances, such as peppermint oil, may be used in the formulations as the scents deter many animals from even approaching the formulations when applied. The denaturants and fragrances are applied to the carrier along with the primary components by the same methods outlined above or may be added later.

The formulation of the hog attractant with peanut butter powder is treated with a denaturant or fragrance to discourage consumption by humans and certain animals. Feral hogs and rats are attracted to all liquids in the formulations, while deer are attracted mainly to the peanuts. Human consumption is by accidental ingestion, primarily. By varying the concentration and type of the denaturant it is possible to tailor formulations which deter consumption by humans and are attractive to hogs, but not deer, rats, squirrels, or other animals. For example, a loading of 10 ppmw of Denatonium Benzoate in the formulations will repel rats and squirrels, but not feral hogs. Formulations containing 0.2 wt % of Denatonium Benzoate will repel deer. A minimal loading of 10 ppbw is bitter to humans and deters consumption, whereas that loading is not detected by animals. Fragrances, such as peppermint oil, may be used in the formulations as the scents deter many animals from even approaching the formulations when applied. The denaturants and fragrances are applied to the carrier along with the primary components by the same methods outlined above or may be added later.

Many other changes and modifications can be made in the system and method of the present invention without departing from the spirit thereof. We therefore pray that our rights to the present invention be limited only by the scope of the appended claims.

We claim:

1. A multiple-loaded non-ceramic dry carrier product comprising:
(i) a non-ceramic carrier material having porous small and granular particles;
(ii) at least one reagent;
wherein said reagent is loaded onto said non-ceramic carrier material and then dried to form a reagent-loaded dry carrier, in repeating iterations until said non-ceramic carrier material is substantially completely loaded with the reagent.

2. The multiple-loaded non-ceramic dry carrier product of claim 1, wherein said non-ceramic carrier material is chosen from a group consisting of perlite, pumice, and scoria.

3. The multiple-loaded non-ceramic dry carrier product of claim 1, wherein said non-ceramic carrier material is chosen from a group consisting of exfoliated vermiculite and activated charcoal.

4. The multiple-loaded non-ceramic dry carrier product of claim 1, wherein each said reagent is a substance chosen from a group consisting of liquids, solutions of solids dissolved in liquids, suspensions, and solids heated to reduce viscosity.

5. The multiple-loaded non-ceramic dry carrier product of claim 1, wherein said reagent further comprises a surfactant chemical.

6. The multiple-loaded non-ceramic dry carrier product of claim 1, wherein said reagent further comprises a microbial enzymatic system.

7. The multiple-loaded non-ceramic dry carrier product of claim 1, wherein said reagent further comprises a substance for animal control.

8. The multiple-loaded non-ceramic dry carrier product of claim 1, wherein said reagent further comprises a fragrance.

9. The multiple-loaded non-ceramic dry carrier product of claim 1, wherein said non-ceramic carrier material has porous small and granular particles with aspect ratios in the range of approximately 0.5:1.0 to 0.95:1.0.

10. The multiple-loaded non-ceramic dry carrier product of claim 1, further comprising more than one said reagent.

11. The multiple-loaded non-ceramic dry carrier product of claim 1, wherein each said reagent further comprises a substance chosen from a group consisting of corrosion inhibitors, scale inhibitors, surfactants, biocides, fungicides, microbial, and enzymatic systems.

12. A multiple-loaded non-ceramic dry carrier method comprising:
(i) providing a multiple-loaded non-ceramic dry carrier product comprising:
(a) a non-ceramic carrier material having porous small and granular particles; and
(b) at least one reagent;
(ii) loading said reagent onto said non-ceramic carrier material;
(iii) drying said reagent loaded onto said non-ceramic carrier material to form a reagent-loaded dry carrier;
(iv) repeating iterations of said loading and drying steps until said non-ceramic carrier material is substantially completely loaded with the reagent; and
(v) using said reagent-loaded dry carrier.

13. The multiple-loaded non-ceramic dry carrier method of claim 12, wherein said reagent is a cleaning chemical and said using said reagent-loaded dry carrier is cleaning hydrocarbon-contaminated formations.

14. The multiple-loaded non-ceramic dry carrier method of claim 12, wherein said reagents are a mixture of surfactants, microbial and enzymatic systems and said using said reagent-loaded dry carrier is oil and stain remediation of concrete and gravel.

15. The multiple-loaded non-ceramic dry carrier method of claim 12, wherein said reagent is an animal control substance, where said non-ceramic carrier material provides time-release and preservative properties to said reagent, and impedes movement of said reagent through soil.

16. The multiple-loaded non-ceramic dry carrier method of claim 12, wherein said reagents are a mixture of an animal control substance active on a first type of animal, and an animal control substance repellant to a second type of animal, discouraging said second type of animal from interacting with said reagent-loaded dry carrier.

17. The multiple-loaded non-ceramic dry carrier method of claim 12, wherein said reagents are a mixture of a first substance and a second substance acting upon said first substance as a preservative.

18. The multiple-loaded non-ceramic dry carrier method of claim 12, wherein said reagents are a mixture of a first substance and a second substance acting upon said first substance as a time-release agent.

19. The multiple-loaded non-ceramic dry carrier method of claim 12, wherein said reagents are a mixture of a first substance and a second substance acting upon said first substance as a buffer.

20. The multiple-loaded non-ceramic dry carrier method of claim 12, wherein said reagents are a mixture of a first substance and a second substance acting upon said first substance as an activator.
